(19) United States
(12) Patent Application Publication
(10) Pub. No.: US 2024/0104663 A1
(43) Pub. Date: Mar. 28, 2024

(54) SYSTEMS AND METHODS FOR DECENTRALIZED CONTRACT MANAGEMENT

(71) Applicant: Change Healthcare Holdings, LLC, Nashville, TN (US)

(72) Inventors: Andras L. Ferenczi, Scottsdale, AZ (US); Srilekha Akula, Fremont, CA (US); Avinash Burra, Oneonta, NY (US)

(21) Appl. No.: 17/936,016

(22) Filed: Sep. 28, 2022

(51) Int. Cl. G06Q 40/08; G06F 40/174; G06F 40/186; G06Q 50/18

(52) U.S. Cl. CPC G06Q 40/08; G06F 40/174; G06F 40/186; G06Q 50/188

(57) ABSTRACT

A contract provider provides a distributed ledger that has a node for each payor, provider, and the contract provider. Each entity controls its own node and has access to private and public keys associated with their node. When a provider desires to create a contract with a provider, the provider uses an application provided by the contract provider. The application has access to various contract related templates, forms and workflows associated with the contracts. The application includes an iframe that connects to the node of the provider. The provider may create a draft contract using the application that is stored on the distributed ledger by the nodes of the provider via the iframe. The payor may then similarly use the application to access the contract via the iframe by contacting to their node. The provider and payor may continue to edit the contract via the application until it is complete.

### BACKGROUND

Contract providers provide contact creation and negotiation tools for medical providers and payors. These tools include libraries of templates and forms that may be used to construct a contract, tools that may be used by either party to edit, modify or change the contract, and workflows that govern the contract creating and negotiation process. These tools allow providers and payors to quickly and efficiently create contracts.

One drawback associated with such contract providers is that by providing the tools that allow medical providers and payors to create and negotiate contracts, the contract providers often control or have access to information that the medical providers and payors may wish to keep private or control themselves.

For example, when creating a contract, a medical provider and payor may exchange several draft contracts through the contract provider, and each draft may include redlines showing edits as well as comments from either party. For various reasons, both the payor and the medical provider may desire that the contract provider not see these draft contracts, and may desire to control where these draft contracts are stored and who is able to access them.

### SUMMARY

To solve these and other problems, distributed ledger technology is used to facilitate the creation of contracts between payors and providers. The contract provider provides a distributed ledger that has a node for each payor, provider, and the contract provider. Each entity controls its own node and has access to private and public keys associated with their node. When a medical provider desires to create a contract with a payor, the provider uses an application provided by the contract provider. The application has access to various contract related templates, forms and workflows associated with the contracts. The application includes an iframe that connects to the node of the provider. The provider may create a draft contract using the application that is stored on the distributed ledger by the node of the provider via the iframe. The payor may then similarly use the application to access the contract via the iframe by connecting to their node. The provider and payor may continue to edit the contract via the application until it is complete.

Because the contract was edited through the nodes, the contract provider is unaware if its contents, but is still able to provide the tools that can be used to create and edit the contract. In addition, because the contract is stored on the distributed ledger, both the provider and payor can be assured that no changes can be made to the contract once it is finalized. Further, the payor and provider may communicate about the contract through a private channel between the nodes provided by the distributed ledger, which provided additional privacy and security to the contract creating and negotiation process.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated herein and form part of the specification, illustrate a contract creation system and method. Together with the description, the figures further serve to explain the principles of the contract creation system and method described herein and thereby enable a person skilled in the pertinent art to make and use the contract creation system and method.

FIG. 1 is an example environment for creating an editing contract using a distributed ledger;

FIG. 2 is an illustration of a method for creating and editing a contract using a distributed ledger;

FIG. 3 is an illustration of a method for creating and editing a contract using a distributed ledger; and

FIG. 4 shows an example computing environment in which example embodiments and aspects may be implemented.

### DETAILED DESCRIPTION

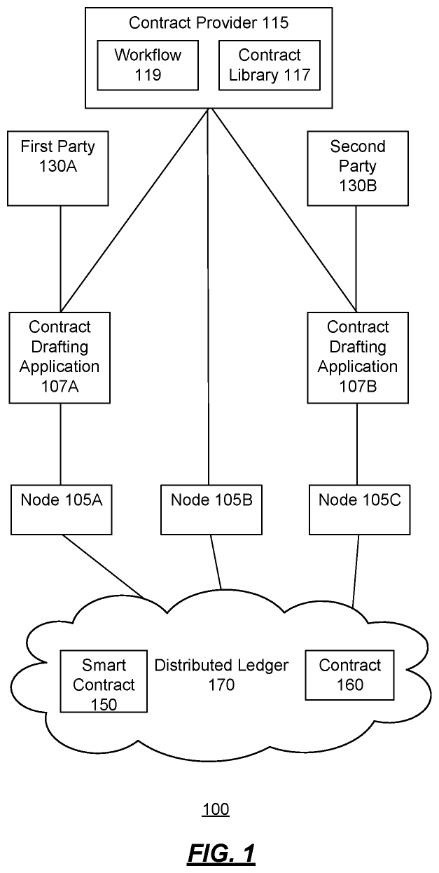

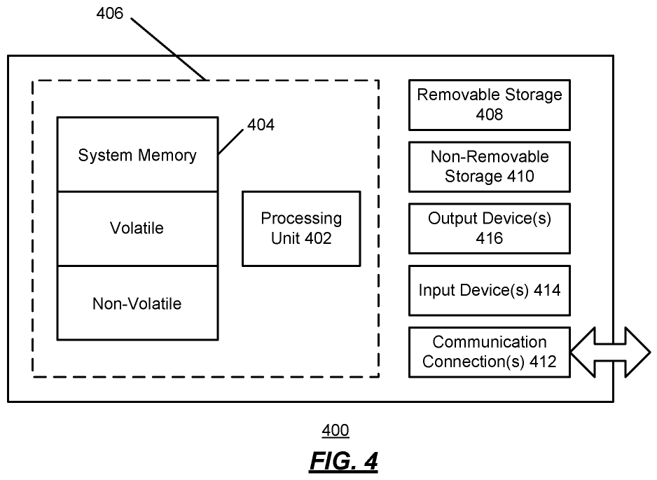

FIG. 1 is an example environment for creating and editing contracts using a distributed ledger. As shown, the environment 100 may include one or more contract providers 115, parties 130 (i.e., the parties 130A and 130B), and one or more nodes 105 (i.e., the nodes 105A, 105B, and 105C). More or fewer parties 130 and nodes 105 may be supported. Each of the contract provider 115 and nodes 105 may be partially implemented by one or more general purpose computing devices such as the computing device 400 illustrated in FIG. 4.

The contract provider 115 may provide a contract drafting application 107 (i.e., the contract drafting applications 107A and 107B) that one or more parties 130 may use to create a contract 160. In some embodiments, the contract 160 may be for reimbursement for medical services provided by a medical provider for patients who are covered by an insurance company or payor. As may be appreciated, payors typically have a contract 160 with each medical provider that they do business with. In such cases, the payor associated with a contract 160 may be the first party 130A and the medical provider associated with a contract 160 may be the second party 1306. Note that the contracts 160 are not limited to two parties, more parties 130 may supported.

The contract provider 115, through the contract drafting application 107, may make available one or more workflows 119 and contract libraries 117 that the parties 130 associated with a contract 160 may use to edit the contract 160. A workflow 119 for a contract 160 may control the steps of contract 160 creation including which party 130 originates the contract 160, how many rounds of edits or negotiations may be permitted, and how long each party 130 is permitted to edit the contract 160 during each round of edits or negotiation. Other information may be included in the workflow 119.

The contract library 117 may include various tools that the parties 130 may use to generate or edit the contract 160. The libraries 117 may include various terms, templates, forms, and items that the parties 130 may use to create their contract 160. For example, the first party 130A may begin creating the contract 160 between the first party 130A and the second party 130B by selecting one or more templates. The contract drafting application 107 may then complete at least some of the one or more templates by inserting known details such as the names and other details of the parties 130A and 130B. The first party 130A may then further select one or more terms from the contract library 117 for the contract 160 and may add the terms into the contract 160.

After the first party 130A completes the contract 160, the contract drafting application 107 may communicate to the second party 130B that the contact 160 is ready for review, and the second party 130B may similarly use the contract drafting application 107 to make further edits or modifications to the terms and conditions of the contract 107 or may indicate that the contract 160 is complete. The first and second party 130A and 130B may continue to make edits back and forth according to a workflow 119 until both parties 130 agree on the contract 160.

As may be appreciated, one problem associated with the use of contract drafting applications 107 provided by contract providers 115, is that the completed contract 160 including drafts, is generally stored by the contract provider 115. This may be problematic for one or both of the parties 130A and 130B who would like to maintain control of the contract 160 and ensure that all drafts or older versions of the contract 160 remain secured and only accessible to the parties 130A and 130B.

Accordingly, to provide increased security and privacy protection to the contracts 160 while still allowing parties 130 to use contract drafting applications 107, in some embodiments, the contract provider 115 may use a distributed ledger 170 to create one or more nodes 105 for each of the parties 130 and the contract provider 115. Each node 105 may be uniquely associated with a party 130 or contract provider 115 and may be associated with cryptographic keys (e.g., public and private keys) that can be used to access the node 105. Each node 105 may include a copy of the distributed ledger 170 and may perform operations with respect to the distributed ledger 170.

Initially when a first party 130A and a second party 130B desire to create a contract 160, the contract provider 115 may facilitate the creation of nodes 105 for the first party 130A and the second party 130B if they do not already have nodes 105. Once the nodes have been created, one of the parties 130 may begin the contract 160 creation process using the contract drafting application 107.

In some embodiments, the contract drafting application 107A used by the first party 130A may include an iframe or other communication means that connects to the node 105A associated with the first party 130A. Using the iframe, the first party 130A may begin constructing the contract 160 using a selected workflow 119 and the contract library 117 provided by the contract provider 115. For example, the first party 130A may use the contract drafting application 107A to drag and drop various terms and templates from the contract library 117 into the iframe. The first party 130A may then edit the contract 160 via the iframe using tools provided by the contract drafting application 107A. Once the first party 130A has completed a first draft of the contract 160, the draft contract 160 may be stored on the distributed ledger 160 by the node 105A. To provide security and to ensure that only the second party 130B may view the contract 160, the contract 160 may be encrypted using the public key of the second party 130B.

As a feature of the distributed ledger 170, private communication channels may be provided between each of the nodes 105, such that the first party 130A and the second party 130B can communicate and negotiate the terms and conditions of the contract 160 privately. After the first party 130A completes the first draft of the contract 160, the first party 130A may send a message to the second party 130B that the contract 160 is complete. The message may include a link to the contract drafting application 107B and/or the contract 160 on the distributed ledger 170.

The second party 130B may similarly use the contract drafting application 107B to view and edit the contract 160. Similarly as described above, the contract drafting application 107B has access to the contract library 117 of the contract provider 115 and an iframe that accesses the contract 160 on the distributed ledger 170 via the node 105C associated with the second party 130B. Depending on the embodiment, where the contract 160 was encrypted using the public key of the second party 130B, the second party 130B may be prompted by the contract drafting application 107B to provide their private key so that the stored contract 160 can be decrypted.

The second party 130B may edit the contract 160 through the iframe of the contract drafting application 107B similarly as described above. In addition, the second party 130B may communicate regarding the contract 160 through the private channel between the nodes 105A and 105C. Once the second party 130B has completed the next draft of the contract 160, the new draft contract 160 may similarly be stored on the distributed ledger 170. In addition, the new draft of the contract 160 may be encrypted using the public key of the first party 130A.

The first party 130A and the second party 130B may continue to review and revise the contract 160 as described above until agreement is reached or as specified in the workflow 119. Once agreement is reached the resulting contract 160 may be stored either of the first party 130A or the second party 130B on the distributed ledger 170, or at a different location. Because the changes and edits to the contract were encrypted and stored on distributed ledger 170, and all information including negotiations and comments was exchanged via private channels, the contract provider 115 may not be aware of the contents of the drafts of the contracts 160 or the particular information that was exchanged between the parties 130 during the creation of the contract 160.

As an additional feature, because information about the contract, including when drafts of the contracts 160 have been completed may be unavailable to the contract provider 115, the contract provider 115 may be unaware of the status or progression of a contract 160 to completion. One feature provided by contract providers 115 is adherence to a workflow 119. For example, previously after a first draft of a contract 160 is completed by a first party 130A, the contract provider 115 may have sent a message to the second party 130B with a link to the contract drafting application 107 and the contract 160. If an amount of time passes that exceeds an amount of time specified in the workflow 119, the contract provider 115 may have sent reminders to the first party 130A and the second party 130B.

To provide similar adherence to one or more workflows 119 in embodiments using the distributed ledger 170, one or more smart contracts 150 may be used to enforce a workflow 119 with respect to the contract 160 and the first party 130A and a second party 130B. As used herein a smart contract 150 is a program stored on the distributed ledger 170 that runs when certain conditions are met. These conditions may include detecting when a contract 160 has been added to the distributed ledger 170, detecting when the contract 160 has been modified by a party 130, and detecting when a specified amount of time has passed. Other conditions may be included.

For example, when a first party 130A connects to a contract drafting application 107A to create a new contract 160 with a second party 130B, the first party 130A may initially select a workflow 119, or a default workflow 119 may be selected. The workflow 119 may specify rules such as a maximum number of draft contracts 160 that may be supported, and the amount of time that each party 130 may be allotted to complete each draft contract 160. Other rules may be supported.

After the first party 130A selects a workflow 119, the contract provider 115 may generate a smart contract 150 that enforces the workflow 119. The contract provider 115 may store the smart contract 150 on the distributed ledger 170. Any method for generating a smart contract 150 may b used.

Initially, the smart contract 150 may detect that the first party 130A has completed and stored a first draft of the contract 160 on the distributed ledger 170 via the node 105A. The smart contract 150, via its programming, may then cause a message to be sent to the contract provider 115 indicating that the first party 130A has stored the contract 160 on the distributed ledger 170. The message may indicate the second party 130B.

In addition, the smart contract 150 may, as party of the workflow 119, send a message to the second party 130B that the first draft of the contract 160 has been created. The message may include a link to the contract drafting application 107B that the second party 130B may use to view and/or edit the contract 160. In addition, the smart contract 150 may set a timer corresponding to an amount of time that the second party 130B is allotted to edit the draft contract 160. If the time expires before the second party completes the second draft contract 160, the smart contract 150 may generate and send a reminder message to the second party 130B (and optionally the contract provider 115 and the first party 130A).

After the second party 130B completes the revisions of the first draft contract 160, and the node 105C stores the second draft contract 160 on the distributed ledger 170, the smart contract 150 may detect the second draft contract 160 on the distributed ledger 170 and may generate and send a message to the first party 130A that includes a link to the contract drafting application 107A and/or the second draft contract 160. In addition, the smart contract 150 may further send a message to the contract provider 115 as described above. Depending on the workflow 119, the smart contract 150 may further set a time based on when any further edits from the first party 130A (i.e., a third draft contract 160) are due.

The smart contract 150 may continue enforcing the workflow 119 and updating the contract provider 115 as described above. Once the contract 160 is completed, the smart contract 150 may update the contract provider 115 and may optionally provide a copy of the completed contract 160 to the contract provider 115 and each of the parties 130.

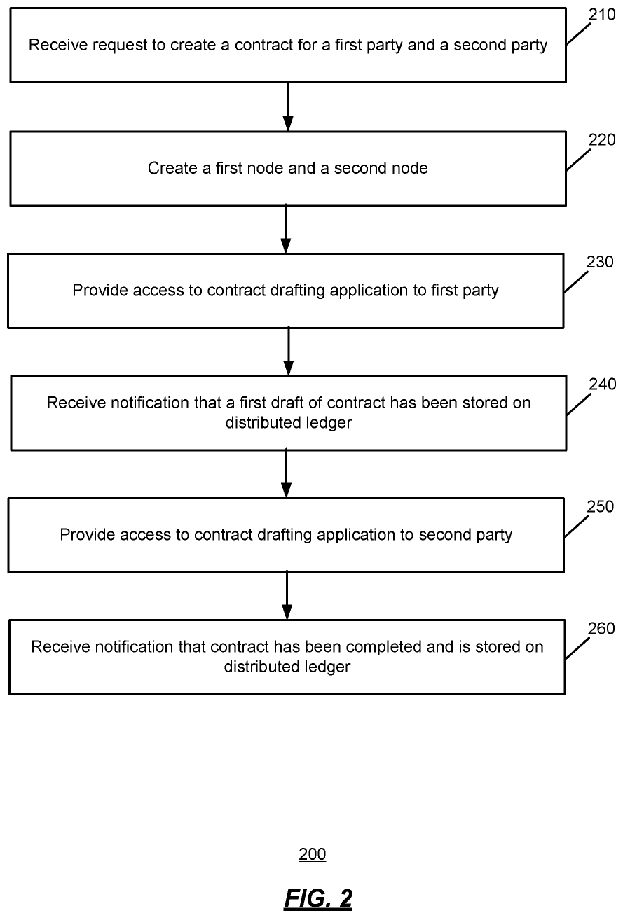

FIG. 2 is an illustration of a method 200 for creating and editing a contract 160 using a distributed ledger 170. The method 200 may be performed by a contract provider 115 and a distributed ledger 170.

At 210, a request to create a contract for a first party and a second party is received. The request may be received by the contract provider 115 from the first party 130A or the second party 130B. The contract provider 115 may provide access to a contract drafting application 107 through which parties 130A and 130B may use to create a contract 160. In some embodiments, the first party 130A may be a medical services provider (e.g., a hospital) and the second party 130B may be a payor of medical services such as an insurance company. The contract 160 may be a contract for the second party 130B to pay for medical services provided by the first party 130A to clients, members, or participants of the second party 130B.

At 220, a first node and a second node are created. The first node 105A and the second nodes 105C may be created on the distributed ledger 170 by the contract provider 115 for the first party 130A and the second party 130B respectively. In some embodiments, the contract provider 115 may only create or assign the nodes 105 to the parties 130 if the parties 130 already do not have a node 105 assigned to them. The nodes 105 may allow the first and second parties 130 to communicate via private message channels that are not accessible to the contract provider 115 or any other entity.

At 230, access to a contract drafting application is provided to the first party. The first party 130A may be provided access to the contract drafting application 107A by the contract provider 115. The contract drafting application 107A may allow the first party 130A to select one or more terms, templates or other items provided in a contracts library 117 to construct a first draft of the contract 160. The contract drafting application 107A may include an iframe that allows the first party 130A to drag and drop items from the contract library into the contract 160 and to store the contract 160 on the distributed ledger via the node 105A.

At 240, a notification that a first draft of the contract has been stored on the distributed ledger is received. The notification may be received by the contract provider 115 from a smart contract 150 associated with the contract 160. The smart contract 160 may watch for a contract 160 associated with the first party 130A to be added to the distributed ledger 170, and in response to the contract 160 being added to the distributed ledger 170, the smart contract 150 may notify the contract provider 115.

At 250, access to the contract drafting application is provided to the second party. Similarly as described above, the contract provider 115 may send a message to the second party 130B that includes a link to the contract drafting application 107B. The message may indicate that the first party 130A has completed a first draft of the contract 160 and may invite the second party 130B to edit the contract 160 using the contract drafting application 107B. The message may further include a date when the second party 130B should complete their edits according to a workflow 119 associated with the contract 160.

Depending on the embodiment, the notification may be provided to the second party 130B by the contract provider 115. Alternatively, the notification may be sent to second party 130B by the smart contract 150 or by the first party 130A using the private channel between the node 105A and the node 105C.

At 260, a notification that the contract has been completed and is stored on the distributed ledger is received. The notification may be provided to the contract provider 115 by the smart contract 150 in response to detecting that the second party 130B has stored a completed contract 160 on the distributed ledger 170.

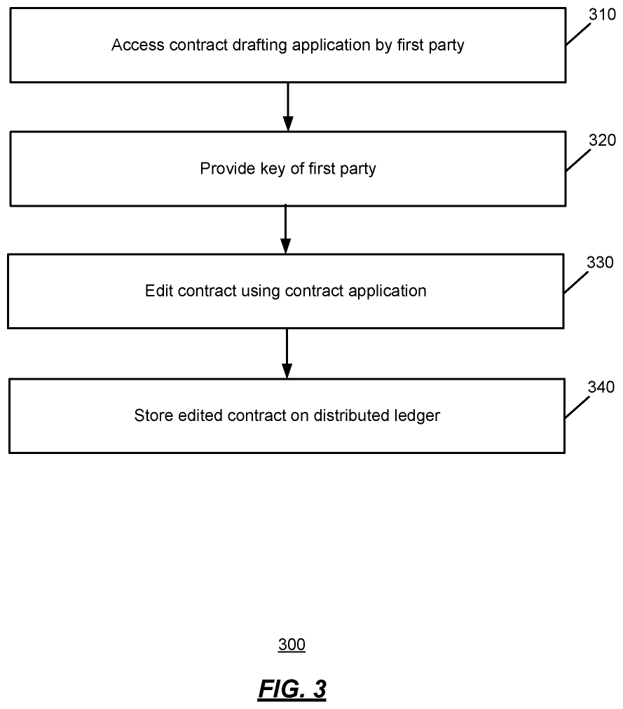

FIG. 3 is an illustration of a method for creating and editing a contract 160 using a distributed ledger 170. The method 200 may be performed by a node 105 of a distributed ledger 170.

At 310, a contract drafting application is accessed. The contract drafting application 107A may be accessed by the first party 130A using a link provided by the contract provider 115. The contract drafting application 107A may include an iframe that allows the first party 130A to access and store documents on the distributed ledger 170 using the first node 105A associated with the first party 130A.

The first party 130A may be working with a second party 130B on the contract 160. The second party 130B may have completed a draft of the contract 160 and may have stored the draft contract 160 on the distributed ledger 170 via the node 105C. The draft contract 160 may be encrypted using a public key of the first party 130A.

At 320, a key of the first party is provided. The key may be a private key of the first party 130A and may be provided to the node 105A via the iframe of the contract drafting application 107A. The private key of the first party 130A may allow the first party to decrypt the encrypted draft contract 160. The decrypted draft contract 160 may be displayed to the first party 130A through the iframe of the contract drafting application 107A.

At 330, the contract is edited using the contract drafting application. The contract 160 may be edited by the first party 130A dragging and dropping elements from the contract library 117 and by editing one or more elements already existing in the contract 160. Depending on the embodiment, the first party 130A may also communicate with the second party 130B regarding the contract 160 using a private channel between the node 105A and the node 105C that is provided by the distributed ledger 170. In particular, the first party and the second party 130 may exchange messages about the contract 160 trough the private channel. Because the messages are exchanged via the private channel, they may not be visible to the contract provider 115 or any other entity that is not a party 130 to the contract 160.

At 340, the first draft of the contract is stored on the distributed ledger. The first draft contract 160 may be stored on the distributed ledger 170 by the node 105C.

FIG. 4 shows an example computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an example system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by the device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communication connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although example implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving a request to create a contract from a first party by a contract provider, wherein the contract is between the first party and a second party, and further wherein the first party is associated with a first node in a distributed ledger and the second party is associated with second node in the distributed ledger;
providing access to a contract drafting application to the first party by the contract provider, wherein the contract drafting application allows the first party to create a first draft of the contract and to store the first draft of the contract on the distributed ledger via the first node;
receiving a notification that the first draft of the contract was stored on the distributed ledger by the first node by the contract provider; and
in response to the notification, providing access to the contract drafting application to the second party by the contract provider, wherein the contract drafting application allows the second party to edit the first draft of the contract to create a second draft contract and to store the second draft of the contract on the distributed ledger via the second node.

2. The method of claim 1, wherein the first party is a medical claims payor, and the second party is a medical provider.

3. The method of claim 1, wherein the notification that the first draft of the contract was stored on the distributed ledger was generated by a smart contract on the distributed ledger.

4. The method of claim 1, wherein the first node and the second node communicate via a private channel between the first node and the second node.

5. The method of claim 1, wherein the contract application includes an iframe that connects to the first node and allows the first party to copy one or more forms, templates, or text provided by the contract provider into the first draft of the contract at the first node.

6. The method of claim 1, wherein the contract provider cannot access the contract, or any drafts of the contract.

7. The method of claim 1, further comprising creating one or more of the first node and the second node in response to receiving the request to create the contract.

8. A method comprising:
accessing a contract drafting application provided by contract provider by a first party, wherein the first party is associated with a first node on a distributed ledger, and wherein the contract drafting application allows the first party to create a first draft of a contract and to store the first draft of the contract on the distributed ledger via the first node, and further wherein the contract is between the first party and a second party, and the second party is associated with a second node on the distributed ledger;
creating a first draft of the contract by the first party using the contract drafting application; and
storing the first draft of the contract on the distributed ledger by the first party using the first node.

9. The method of claim 8, further comprising:
sending a message to the second party by the first party about the first draft of the contract via a private channel between the first node and the second node in the distributed ledger.

10. The method of claim 8, wherein creating the first draft of the contract by the first party using the contract drafting application comprises:
viewing one or more forms, templates, or text items provided by the contract drafting application;
selecting at least one of the one or more forms, templates, or text items by the first party; and
adding the at least one of the one or more forms, templates, or text items by the first party to the first draft of the contract.

11. The method of claim 9, wherein adding the at least one of the one or more forms, templates, or text items by the first party to the first draft of the contract comprises adding the at least one of the one or more forms, templates, or text items to an iframe in the contract drafting application, wherein the iframe connects to the first node of the distributed ledger.

12. The method of claim 8, further comprising:
receiving a message from the second party via a private channel between the first node and the second node in the distributed ledger, wherein the message relates to a second draft of the contract stored on the distributed ledger; and
using the contract drafting application to view the second draft application on the second ledger via the first node.

13. The method of claim 12, further comprising providing a private key associated with the first node and the first party prior to viewing the second draft application.

14. The method of claim 8, wherein the contract provider cannot access the contract, or any drafts of the contract.

15. The method of claim 8, wherein the first party is a medical claims payor, and the second party is a medical provider.

16. A system comprising:
at least one computing device associated with a contract provider; and
a computer-readable medium storing computer executable instructions that when executed by the at least one computing device cause the system to:
receive a request to create a contract from a first party, wherein the contract is between the first party and a second party, and further wherein the first party is associated with a first node in a distributed ledger and the second party is associated with second node in the distributed ledger;
provide access to a contract drafting application to the first party, wherein the contract drafting application allows the first party to create a first draft of the contract and to store the first draft of the contract on the distributed ledger via the first node;
receive a notification that the first draft of the contract was stored on the distributed ledger by the first node by the contract provider; and
in response to the notification, provide access to the contract drafting application to the second party, wherein the contract drafting application allows the second party to edit the first draft of the contract to create a second draft contract and to store the second draft of the contract on the distributed ledger via the second node.

17. The system of claim 16, wherein the first party is a medical claims payor, and the second party is a medical provider.

18. The system of claim 16, wherein the notification that the first draft of the contract was stored on the distributed ledger was generated by a smart contract on the distributed ledger.

19. The system of claim 16, wherein the first node and the second node communicate via a private channel between the first node and the second node.

20. The system of claim 16, wherein the contract application includes an iframe that connects to the first node and allows the first party to copy one or more forms, templates, or text provided by the contract provider into the first draft of the contract at the first node.
